(19) United States
(12) Patent Application Publication
(10) Pub. No.: US 2025/0358217 A1
(43) Pub. Date: Nov. 20, 2025

(54) METHOD AND APPARATUS FOR PACKET FORWARDING IN A MANHATTAN GRID NETWORK

(71) Applicant: Huawei Technologies Co., Ltd., Shenzhen (CN)

(72) Inventor: William Carson McCormick, Markham (CA)

(21) Appl. No.: 19/290,808

(22) Filed: Aug. 5, 2025

Related U.S. Application Data
(63) Continuation of application No. PCT/CN2023/090013, filed on Apr. 23, 2023.

(51) Int. Cl. H04L 45/122; H04L 45/24; H04L 47/125; H04L 49/101

(52) U.S. Cl. CPC H04L 45/122; H04L 45/24; H04L 47/125; H04L 49/101

(57) ABSTRACT

A method of routing a packet in a network with a Manhattan grid geometry arranged in columns and rows, including receiving, by a source network node, a packet and extracting a destination address of the destination node. Each of the links of the network has a nominal routing cost of one hop and the plurality of links including additional links connecting respective opposing ends of each of the plurality of columns and opposing ends of each of the plurality of rows of the Manhattan grid. Then determining a plurality of distances between the source network node and the destination network node based on the Manhattan grid geometry. Selecting a minimum distance from the plurality of distances and transmitting the packet on an interface associated with the minimum distance.

### CROSS-REFERENCE TO RELATED APPLICATIONS

This application is a continuation of International Patent Application No. PCT/CN2023/090013, filed Apr. 23, 2023, entitled “METHOD AND APPARATUS FOR PACKET FORWARDING IN A MANHATTAN GRID NETWORK” the contents of which are incorporated herein by reference in its entirety.

### TECHNICAL FIELD

This disclosure pertains generally to the field of network communications and in particular to a method and apparatus for routing packets in a satellite network based on a Manhattan grid topology based on distances between network nodes.

### BACKGROUND

A Manhattan grid network or, simply a Manhattan grid, is a known network geometry that is organized, physically or logically, in a rectangular grid, similar to the network of avenues and streets found on Manhattan island in New York. When used in the field of networking, the Manhattan grid geometry may be viewed as a plurality of columns being intersected by a plurality of rows. Network nodes or vertices are located along the columns and rows and are typically located at the intersections of the rows and columns. The connection between two intersections is referred to as a link.

Manhattan grid networks may use a distance metric for computing or measuring the distance between any pair of nodes in the network by assigning a uniform cost (nominally 1) to each link in the network. The distance metric may be computed as the sum of the vertical hops (i.e., the number of links) between the nodes plus the sum of the horizontal hops between the nodes.

A type of Manhattan grid network includes additional links that “wrap around” or connect every node in the last column back to a corresponding node in the first column, and every node in the last row back to a corresponding row in the first row.

Routing solutions have been proposed for Manhattan grid networks that include the use of a type of Equal Cost Multi-Path (ECMP) network routing strategy but fail to take advantage of efficiencies that are possible using a Manhattan grid network as a result of their specific geometry.

Therefore, there exists a need for an improved routing strategy that takes advantage of the characteristics of a Manhattan grid network, that alleviates the restrictions of the prior art.

This background information is provided to reveal information believed by the applicant to be of possible relevance to the present invention. No admission is necessarily intended, nor should be construed that any of the preceding information constitutes prior art against the present invention.

### SUMMARY

Embodiments provide methods and systems for forwarding packets in a router or switch of a Manhattan grid network that includes links that wrap around from columns on one side of the grid to the column on the opposite side, and from rows that wrap around from one side of the grid to the row on the opposite side.

Embodiments include a distance metric for computing a distance between pairs of network nodes in the network by assigning a cost, which may be a uniform cost of 1, to each link in the network. The distance metric may be the sum of the vertical hops between the network nodes plus the sum of the horizontal hops between the network nodes.

Since the Manhattan grid network of embodiments “wraps around” at the edges, there are two candidate distances in each of the horizontal and vertical directions.

In accordance with an aspect of the present invention, there is provided a method of routing a packet in a network including receiving, by a source network node, a packet and extracting a destination address from the packet where the destination address specifies a destination network node. The network has a Manhattan grid geometry including a plurality of columns and a plurality of rows, with a plurality of network nodes being located at intersections of the plurality of columns and the plurality of rows. A plurality of links aligned with the plurality of columns and the plurality of rows communicatively connect the plurality of network nodes. For routing and distance calculation purposes, each of the plurality of links has a nominal routing cost of one hop. The plurality of links include additional links connecting respective opposing ends of each of the plurality of columns and opposing ends of each of the plurality of rows. The source network node and the destination network node being included in the plurality of network nodes. Also, determining, by the source network node, a plurality of distances between the source network node and the destination network node, where each of the plurality of distances determined by adding a vertical distance in rows between the source network node and the destination network node and a horizontal distance in columns between the source network node and the destination network node. The vertical distance is measured in both directions along a source row where the source network node is located, and the horizontal distance is measured in both directions along a source column where the source network node is located. Then, selecting, by the source network node, a target minimum distance from the plurality of distances, and transmitting, by the source network node, the packet on an interface associated with the target minimum distance.

Further embodiments include receiving, by the source network node, an equal cost multi-path (ECMP) hint when determining that at least two of the plurality of distances are equal to a minimum distance, where the, selecting, by the source network node, the target minimum distance from the plurality of distances includes, selecting, by the source network node, utilizing the ECMP hint, the target minimum distance from the at least two of the plurality of distances.

In accordance with another aspect of the present invention, there is provided a method of routing a packet in a network including receiving, by a source network node, a packet and extracting a destination address from the packet where the destination address specifies a destination network node. The network has a Manhattan grid geometry including a plurality of columns and a plurality of rows. A plurality of network nodes are located at intersections of the plurality of columns and the plurality of rows with a plurality of links aligned with the plurality of columns and the plurality of rows communicatively connecting the plurality of network nodes. Each of the plurality of links may have a nominal routing cost of one hop. The plurality of links including additional links connecting respective opposing ends of each of the plurality of columns and opposing ends of each of the plurality of rows. The source network node and the destination network node are included in the plurality of network nodes. Also, determining, by the source network node, a plurality of distances between the source network node and the destination network node. Receiving, by the source network node, an equal cost multi-path (ECMP) hint when at least two of the plurality of distances are equal to a minimum distance, and selecting, by the source network node, utilizing the ECMP hint, a target minimum distance from the at least two of the plurality of distances. Finally, transmitting, by the source network node, the packet on an interface associated with the target minimum distance.

In further embodiments, each of the plurality of distances is combined with an associated interface of the source network node into a distance-interface tuple. Each of the distance-interface tuples includes a distance between the source network node and the destination network node, and an interface to transmit the packet to reach the destination network node on a route of a length equal to the distance. The distance is expressed as a number of hops in the route.

In further embodiments, the network is a satellite network, and the plurality of network nodes are satellites. The plurality of columns includes a plurality of orbits in a longitudinal direction. The plurality of links aligned with the plurality of columns include a plurality of intra-orbital links, and the plurality of links aligned with the plurality of rows include a plurality of inter-orbital links.

In further embodiments, the ECMP hint indicates selecting a distance along the plurality of rows over a distance along the plurality of columns.

In further embodiments, the ECMP hint indicates no preference.

These methods provide the technical benefit of using the known properties of a Manhattan grid network to simplify distance calculations and allow for simple methods of calculating the distances. For a regular Manhattan grid network geometry, there are only 4 distances to be calculated that simplifies hardware design and allows for calculations to be performed quickly. The use of a routing (ECMP) hint allows for the quick selection of a distance/interface tuple and the ECMP hint may be customized to account for small differences in routing distances to account for variations in the Manhattan grid, such as in the case of a satellite network.

In accordance with another aspect of the present invention, there is provided a network node for routing a packet in a network. The network node includes a plurality of distance modules, with each of the plurality of distance modules receiving an address of one of a plurality of other network nodes and one of a plurality of output interfaces associated with the one of the plurality of other network nodes. Each of the plurality of distance modules also receives a destination address of the packet. Each of the plurality of distance modules is configured to compute a distance between a source network node and a destination network node indicated by the destination address. Also, a comparator module receiving the distance and the output interface from each of the plurality of distance modules. The comparator module may also receive an equal cost multi-path (ECMP) hint. The comparator module outputs a target minimum distance and an output interface corresponding to the target minimum distance.

In further embodiments, the network node is the source network node.

In further embodiments, the network is a Manhattan grid network including a plurality of columns and a plurality of rows, and the network node, the destination network node, and the plurality of other network nodes are located at intersections of the plurality of columns and the plurality of rows with a plurality of links aligned with the plurality of columns and the plurality of rows communicatively connecting the network node, the destination network node, and the plurality of other network nodes. Each of the plurality of links has a nominal routing cost of one hop. The plurality of links includes additional links connecting respective opposing ends of each of the plurality of columns and opposing ends of each of the plurality of rows.

In further embodiment, the network is a satellite network, and the network node, the destination network node, and the plurality of other network nodes are satellites. The plurality of columns include a plurality of orbits in a longitudinal direction. The plurality of links are aligned with the plurality of columns include a plurality of intra-orbital links, and the plurality of links aligned with the plurality of rows include a plurality of inter-orbital links.

In further embodiment, the distance is determined by adding a vertical distance in rows between the network node and the destination network node and a horizontal distance in columns between the network node and the destination network node. The vertical distance is measured in both directions along a source row where the source network node is located. The horizontal distance is measured in both directions along a source column where the source network node is located.

In further embodiments, the target minimum distance is a minimum of the distances received from the plurality of distance modules.

In further embodiments, at least two minimum distances received from the plurality of distance modules are equal and the ECMP hint is used to select the target minimum distance between the at least two distances.

In further embodiments, the ECMP hint give priority to a distance along the plurality of rows over a distance along the plurality of columns.

In further embodiments, the ECMP hint indicates no preference.

The network node provides the technical benefit of including simplified hardware optimized for use in a Manhattan grid network of regular columns and rows that wrap around at the ends. In embodiments, only four distances must be calculated for each destination node and a minimum distance may be easily selected from just four or a similarly small number of options. The inclusion of a routing (ECMP) hint allows for further optimizations in cases where two or more routing distances are the same or when the Manhattan grid geometry is not uniformly square and distances between network nodes differ, as is the case in a satellite network.

In further embodiments, the network node is a component, or an apparatus comprised in the network node.

In accordance with another aspect of the present invention, there is provided an apparatus comprising at least one processor coupled with a memory storing instructions, when the instructions are executed by the at least one processor, cause the apparatus to perform the method mentioned above.

In accordance with another aspect of the present invention, there is provided a network or system for routing a packet. Where in the network or system comprising the network nodes (apparatus) mentioned above.

In accordance with another aspect of the present invention, there is provided computer program comprising instructions, when the instructions are executed by an apparatus, cause the apparatus to perform the method mentioned above.

Embodiments have been described above in conjunction with aspects of the present invention upon which they can be implemented. Those skilled in the art will appreciate that embodiments may be implemented in conjunction with the aspect with which they are described but may also be implemented with other embodiments of that aspect. When embodiments are mutually exclusive, or are otherwise incompatible with each other, it will be apparent to those skilled in the art. Some embodiments may be described in relation to one aspect, but may also be applicable to other aspects, as will be apparent to those of skill in the art.

### BRIEF DESCRIPTION OF THE DRAWINGS

Further features and advantages of the present invention will become apparent from the following detailed description, taken in combination with the appended drawings, in which;

FIG. 1 illustrates a schematic of a Manhattan grid network, according to an embodiment.

FIG. 2 illustrates a schematic of a satellite network as may be used for a Walker Delta topology, according to an embodiment.

FIG. 3 illustrates a forwarding system architecture, according to an embodiment.

FIG. 4 illustrates a distance module, according to an embodiment.

FIG. 5 illustrates a controlled comparator, according to an embodiment.

FIG. 6 illustrates an ECMP module, according to an embodiment.

FIG. 7 illustrates method 700 for routing a packet in a network with a Manhattan geometry according to an embodiment.

FIG. 8 illustrates an electronic device, according to an embodiment, that may be used to implement any of the methods described herein.

It will be noted that throughout the appended drawings, like features are identified by like reference numerals.

### DETAILED DESCRIPTION OF ILLUSTRATIVE EMBODIMENTS

Embodiments of the present invention provides methods and systems for forwarding packets in a router or switch of a Manhattan grid network. Network nodes are joined by links that may extend in each of the four directions of the grid. Links may wrap around from columns on one side of the grid to the column on the opposite side, and from rows that wrap around from one side of the grid to the row on the opposite side.

As used herein, a link is a connection between network nodes used for communications. In a Manhattan grid network, a link may connect two adjacent network nodes. Links may be unidirectional or bi-directional. A packet, or other type of message, travelling between two network nodes may travel over multiple links. For example, the packet may be sent from a source network node over a first link to an intermediate network node, and then over a second link from the intermediate network node to a destination network node. In this example, a distance between the source network node and the destination network node may be measured in “hops.” In this case, the distance is two hops since the packet is sent over two links between the source network node and the destination network node. Alternatively, the distance may be referred to as having a “cost” as it costs more to transmit a packet a longer distance (more hops) than a shorter distance (less hops). In the case of a satellite network, a link may be between two adjacent satellites in the same orbit. A link may also be between two satellites in adjacent orbits.

In order make routing decisions, embodiments include a distance metric for computing a distance between pairs of network nodes in the network by assigning a cost, which may be a uniform cost of 1, to each link in the network. Various distance metrics may be used including a distance metric that is the sum of the vertical hops (each link has a distance/cost of 1 hop) between the network nodes plus the sum of the horizontal hops between the network nodes.

Since the Manhattan grid network of embodiments “wraps around” at the edges, there are two candidate distances in each of the horizontal and vertical directions and packets may be forwarded in either direction.

Embodiments also include a system architecture to route packets in a Manhattan grid network that includes a forwarding table, a distance module and an ECMP module. Packets include a packet header, a destination address, and may also include an ECMP hint. The packet body carries the packet payload. The forwarding table includes a list of addresses of other network nodes known to a network node, and an output link interface that may be used to reach the other network nodes. There is a distance module for each entry in the forwarding table that computes the distance between the address in the entry in the forwarding table and the destination address in the packet header. The distance module selects a minimum distance from four possible vertical and horizontal offsets between any two network nodes in the network. The ECMP module includes a plurality of comparator modules which may accept a control input that allows for the selection of a minimum distance based on criteria other than a number of links or hops between the network nodes. The ECMP module also outputs the interface (the output link) on which the packet is to be forwarded.

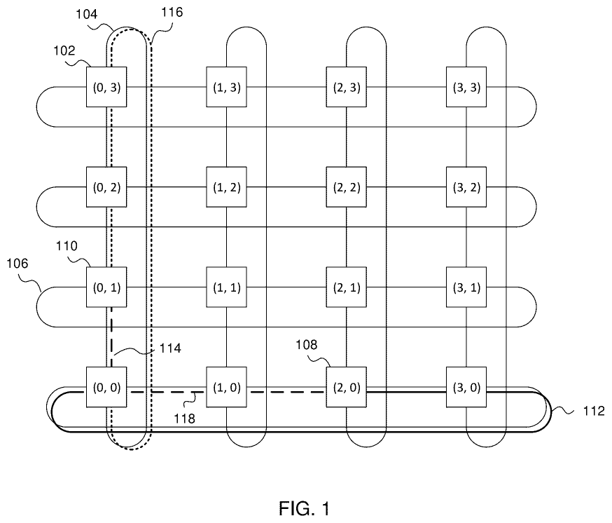

FIG. 1 illustrates a generic Manhattan grid network that may be used in embodiments. As used herein, a Manhattan network, a Manhattan grid, or a Manhattan grid network refers to a network organized in a physical or logical rectangular grid. Network nodes, which may be referred to simply as nodes, may be any physical networking device that may be configured to perform routing or switching functions that involve the routing of packets and include both hardware and software components as is known in the art. For simplicity, network nodes may be referenced by their position at an intersection of a column and a row in the Manhattan grid network. For example, network node 102 is located at the intersection of column 0 and row 3 so may be referenced as network node (0, 3). Similarly, network node 108 is located at the intersection of column 2 and row 0 so may be referenced as network node (2, 0). Routing along columns may also be referred to as a routing, transmission, etc. in a vertical direction. Routing along rows may also be referred to as a routing, transmission, etc. in a horizontal direction. Network nodes may communicate with each other over links between them, illustrated by lines between the network nodes. In embodiment, nodes at the edges may have links that wraparound to the opposite edge of the grid as illustrated at the ends of columns and rows, for example link 106 that directly connects the two network nodes (0, 1) 110 and (3, 1). Link 104 directly connects network node (0, 3) 102 and (0, 0).

The term “Manhattan” grid network is based on the pattern of avenues and streets in Manhattan, New York which includes physically straight road that intersect at right angles. However, the Manhattan grid networks of embodiments described herein may be defined by the grid of network nodes and connecting links, rather than geographic locations. Network nodes are not required to be geographically arranged in straight lines, columns and rows are not required to intersect at right angles. Furthermore, the distance between network nodes do not have to be equal, though it is advantageous that the propagation delays between any two adjacent network nodes is substantially equal, or failing that, that the signal propagation delays are known.

In the Manhattan grid network, each network node has four bidirectional links leading to and from their four closest neighboring nodes in the network. In embodiments, it is advantageous that each network node has all four links operating bidirectionally, though embodiments may still be used in cases where a network node is missing a link or has a link that is temporarily inoperable.

A schematic of a Manhattan grid network is shown in FIG. 1. Network nodes, such as network node 102, in the network are given an address based on the intersection in the grid where they are located. As described herein, a network node address is written in the format (column number, row number), though other addressing formats may also be used. For example, network node 102 may be referred to as being at address (0, 3) as it is located at the intersection of column 0 and row 3.

As illustrated, the network “wraps around” at the edges. Every node in the last column connects back to a corresponding node in the first column, and every node in the last row connects back to a corresponding note in the first row. For example, link 104 wraps around between network node (0, 0) and network node (0, 3). Also, link 106 wraps around between network node (0, 1) and network node (3, 1). The links that wrap around provide two routes between network nodes in the same row or column. For example, a packet being sent between network node (1, 1) and network node (3, 1) may travel horizontally to the right from network nodes (1, 1) to (2, 1), and arrive at (3, 1). A packet may also travel horizontally to the left from network nodes (1, 1) to (0, 1), and arrive at (3, 1) using link 106. Similarly, packets sent along columns may travel vertically in an upwards or downwards direction.

In embodiments, a distance metric can be defined for computing the distance between any pair of nodes in the network. A distance may be correlated with a propagation delay and be used to minimize the propagation delay of packets in the network by minimizing the distance, or minimizing the time required for the packet to travel from a source network note to a destination network node. In a network with a Manhattan grid geometry, where the distance or propagation delay between each pair of neighboring network nodes is similar, a uniform cost (nominally 1) may be assigned to each link or hop in the packet's path. This allows a distance metric that is the sum of the vertical hops between the network nodes plus the sum of the horizontal hops between the network nodes to be used. The use of a relatively simple distance metric provides the technical benefit that distances are easy to calculate and allows for routing decisions to be done quickly with limited computational resources or with lower power requirements.

Since the network “wraps around” at the edges, there are two candidate distances that may be calculated in each of the horizontal and vertical directions for a total of four distances. FIG. 1 illustrates distances for possible routes that a packet may take between nodes (0,1) 110 and (2,0) 108. For each of the possible routes, there is an associated distance and evaluating the plurality of possible routes yields a plurality of distances corresponding to those routes. In the figure, the candidate vertical distances are shown by dotted line 116 and by dashed line 114. Candidate horizontal distances are shown by dashed line 118 and solid line 112. Routing in packet networks always tries to minimize distance, so the total distance between the two network nodes 108 and 110, is the sum of the shortest horizontal distance plus the shortest vertical distance.

The candidate horizontal distances between network nodes (0,1) and (2,0) are path 112 and path 118, both with a horizontal distance of two. The candidate vertical distances between network nodes (0,1) and (2,0) are path 114 and path 116. Path 114 has a distance of 1 and path 116 has a distance of 3. Therefore, the distance metric defined as the minimum horizontal distance plus the minimum vertical distance, would be 2+1=3. Also note that in this case there are several equal cost paths between nodes (0,1) and (2,0). These paths are:

$$\begin{matrix}a . ( 0 , 1 ) \to ( 0 , 0 ) \to ( 1 , 0 ) \to ( 2 , 0 ) \\ b . ( 0 , 1 ) \to ( 1 , 1 ) \to ( 1 , 0 ) \to ( 2 , 0 ) \\ c . ( 0 , 1 ) \to ( 1 , 1 ) \to ( 2 , 1 ) \to ( 2 , 0 ) \\ d . ( 0 , 1 ) \to ( 0 , 0 ) \to ( 3 , 0 ) \to ( 2 , 0 ) \\ e . ( 0 , 1 ) \to ( 3 , 1 ) \to ( 3 , 0 ) \to ( 2 , 0 ) \\ f . ( 0 , 1 ) \to ( 3 , 1 ) \to ( 2 , 1 ) \to ( 2 , 0 )\end{matrix}$$

This scenario with multiple paths of the same cost or distance is referred to as equal-cost multipath and embodiments may make use of equal-cost multi-path routing (ECMP) routing which includes routing algorithms where packet forwarding to a single destination can occur over multiple lowest cost (“best”) paths which tie for the minimum distance using a chosen distance metric calculation.

In this disclosure, a distance represents a path between the source network node and the destination network node, multiple distances represent different paths between the source network node and the destination network node, and multiple distances with same or equal value represent different paths with same distances between the source network node and the destination network node. Hence, selecting a minimum distance presents selecting a path with a minimum distance.

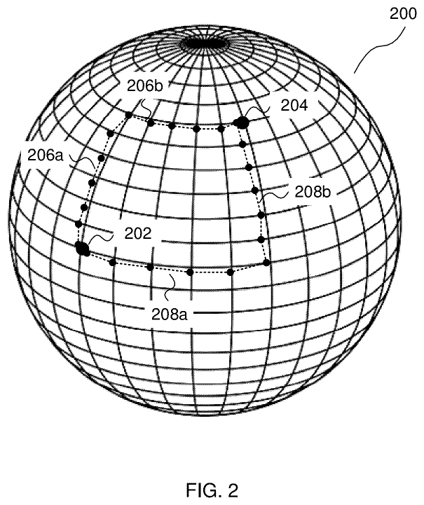

FIG. 2 illustrates a variant of a Manhattan grid network as may be used by a satellite network. Embodiments may apply routing and packet forwarding methods to a Manhattan grid network as implemented in a satellite constellation with intersatellite links. The satellite constellation needs to be arranged topologically into a Manhattan-like grid, for example, in a Walker Delta topology. A Walker Delta topology includes a plurality of equally spaced planes defining orbits. Planes may have an inclination, and therefore, orbits are similarly inclined. Each orbit may have a number of satellites with a relative spacing between satellites in the same orbit. A Walker Delta topology is further defined by having near-polar orbits. Each orbit includes a portion where satellites are travelling in a northerly direction, where after crossing the polar region, the satellites then travel in a southerly direction, thereby allowing the orbits to span 360 degrees around the equator.

In embodiments, each network node may be a satellite. Each column in the Manhattan grid may be thought of as corresponding to an orbital plane of the satellite constellation, with each satellite travelling within its orbit (“column”) in a “vertical,” substantially north-south direction. Similarly, each row in the Manhattan grid may be seen as corresponding to a “phase” in the orbital plane where satellites are located. In the satellite constellation, radio or optical links are established between adjacent satellites. Inter-orbital transmissions between satellites may be viewed as transmissions in a vertical, column, direction. Distances between satellites in the same orbit may be viewed as a vertical distance in either a northernly or southernly direction. Inter-orbit transmissions between satellites in adjacent orbits may be viewed as transmissions in a horizontal, row, direction. Distances between satellites in adjacent orbits may be viewed as a horizontal distance in either an easternly or westerly direction.

Embodiments allow for high performance forwarding decisions to be made at each network node in the network. As used herein, forwarding refers to a local decision, made at a network node, of processing a packet received on one link in order to send it out on a subsequent link. Using this terminology, forwarding is distinct from routing as routing refers to the aggregate activity of moving packets from a source node to a destination node. Forwarding performance is a key factor in network performance. The forwarding system needs to be able to make forwarding decisions at line rates, e.g., a forwarding decision for a packet must be made sufficiently fast when the packet is received, before the next packet arrived, in order to prevent buffer overflow, and other occurrences that may lead to delays, dropped packets, etc.

When a Manhattan grid is applied to a satellite constellation, each link may be assigned the same cost metric. Due to the structure of the Manhattan grid, any source destination pair will have multiple equal cost paths between them. This situation is known as “equal-cost multipath” or ECMP, as described above.

A satellite constellation 200 has certain properties that can be exploited to improve ECMP forwarding decisions. Referring to FIG. 2, which illustrates a polar satellite constellation, the north-south links (i.e., inter-orbital links in the orbital plane) always have substantially the same physical length. However, the east-west intra-orbital link (i.e., the links between orbital planes) have different lengths that become shorter at the poles (the top and bottom of the constellation) and have longer lengths near the equator. This property can be exploited to make better ECMP decisions in many cases.

Consider the paths shown in FIG. 2 for travelling between a network node 202 and a network node 204. Each of the paths may include multiple links of connections between satellites in the same orbits (intra-orbital links) or between orbits (inter-orbital links). The path including sets of multiple links 206a and 206b is physically shorter than the path including sets of multiple links 208a and 208b, mainly because intra-orbital link 206a, closer to the pole, is significantly shorter than inter-orbital link 208a, near the equator. Meanwhile intra-orbital links 206a and 208b are substantially equal. Most of the delays in the satellite network are dominated by speed of light propagation delays between satellite network nodes, so physical path length is an important metric in optimizing packet forwarding decisions.

Travelling from network node 202 to network node 204, a forwarding system should give preference to going in the North direction first, and then in the East direction. Conversely, when travelling from network node 204 to network node 202, the forwarding system should prefer to go in the West direction first, and then in the South direction. These choices minimize the distance travelled on the East-West links, that is the difference in distance between link 206b and 208a.

In embodiments, when a packet enters the satellite constellation, it can be labelled with an “ECMP hint” that will provide the forwarding system with an indication of which direction to take in ECMP forwarding.

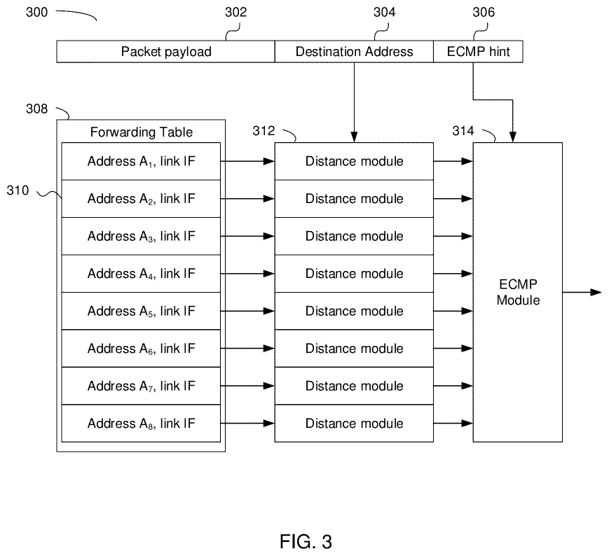

Embodiments include a forwarding system architecture as illustrated in FIG. 3. Apparatus or systems that implement the architecture may be configured to perform methods of packet forwarding in a Manhattan grid network as described herein. In some embodiments, support for making ECMP hints to enable ECMP forwarding is also included.

A packet 300 may have different forms depending on the communications protocol it is compliant with. In embodiments, a packet 300 will include, in addition to a packet payload 302, a destination address 304 and an ECMP hint 306.

A forwarding system apparatus may be divided into three stages. The first stage includes a forwarding table 308. The second stage includes a plurality of distance modules 312. The third stage includes an ECMP module 314. As will be understood by those skilled in the art, the functions of these three stages may be combined or divided into more or less stages or modules and alternative embodiments may also change the order of the functions while still implementing the teachings as described herein. Generally, embodiments will include a module which computes a Manhattan distance metric between the addresses of any two network nodes. A module used to pick the shortest Manhattan distance with support for ECMP decisions. An “ECMP hint” 306 in the data packet 300 which may be used by the forwarding tree to prioritize particular directions, for example, by prioritizing East-West directions with respect to North-South directions. Priorities as embodiment in the ECMP hint 306 may differ depending on logical, physical, or geographic network topology and the dynamic or stationary location of network nodes.

Returning to the forwarding system architecture of FIG. 3, the system may include the following components. A forwarding table 308, which is a list of addresses 310 of other network nodes known to the network node that has received packet 300 and is to make a forwarding decision. The forwarding table also includes the interface (IF) that may be used by the network node to reach the other network node indicated by the address. For example, if network node (1, 2) has received packet 300, the forwarding table 308 may include a list of addresses 310 and link interfaces for other network nodes (0, 2)—left, (1, 3)—up, (1, 1)—down, and (2, 2)—right. In embodiments, the network node addressing formats and the link interface formats may vary depending on the communications and network protocols and formats used.

For each of the list of addresses 310 in the forwarding table 308, there is a distance module 312. For possible routes between the network node and the destination network node, as indicated by the packet destination address 304, the distance module may be used to compute the distance between the address in the entry for the other node in the forwarding table 308 and the destination address 304 in the packet header of packet 300. Each distance module 312 outputs a computed distance and the interface received from the forwarding table 308 that corresponds to the list of addresses 310.

The outputs of the distance modules 312 are input into an ECMP module 314. The ECMP module compares the outputs from the distance modules 312 and selects an interface based on the distances received from the distance modules 312 and the ECMP hint 306 received in the packet 300. The ECMP module outputs the interface on which the packet is to be forwarded and the network node transmits the packet on the selected link interface.

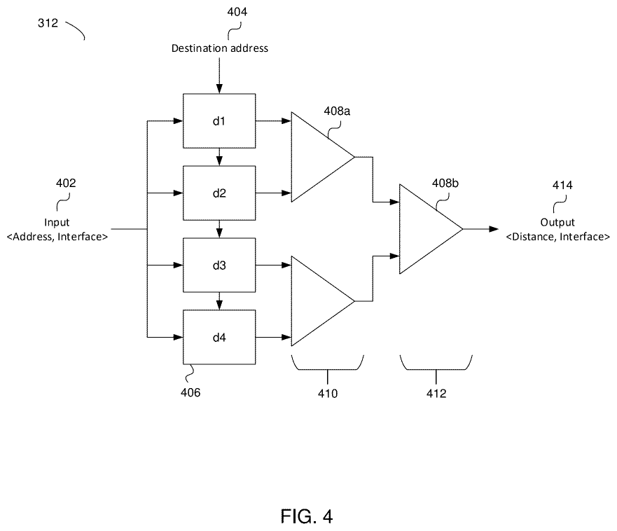

FIG. 4 illustrates an embodiment of a distance module 312. The distance module 312 receives an address and the interface tuple, <address, interface> 402 associated with one of the addresses of the forwarding table 308. It also directly or indirectly receives the destination address 404 from the received packet 300. The distance module 312 utilizes a plurality of computation blocks 406 to determine a plurality of distances of possible routes between the network node of address 402 and the network node indicated by the packet 300 destination address 404. The distances may be Manhattan distances based on a number of hops in a route and the uniform cost (nominally 1) of each link in the network. The distance module 312 then uses one or more stages 410 and 412 of a comparator network 408a and 408b to select a distance, which may be a shortest distance of the distances determined by the computational blocks 406. The output from the distance module 312 is a distance-interface tuple 414 (which may be expressed as <distance, interface>) that contains the shortest distance and the interface that the network node of tuple 402 should use to forward the packet 300 on in order to realize the selected (minimum) distance of the packet's route.

In embodiments, given a Manhattan grid network geometry, each computational block 406 may be used to calculate a horizontal offset and a vertical offset in the opposite horizontal directions and the opposite vertical directions. In a satellite network based on a Manhattan grid geometry, each vertical column may be viewed as an orbit, o, and each horizontal row may be viewed as a position of satellite, s, in that orbit. In this case, the satellite network will have Nₛ orbits with Nₛ satellites in each orbit. With reference to FIG. 1, Nₒ=4 and Nₛ=4. Therefore, a distance between a source satellite, a, (i.e., a source network node) and a destination satellite, b, (i.e., a destination network node) may be calculated as a vertical distance (the number of satellite positions) between the two nodes plus a horizontal distance (the number of orbits) between the two nodes. Furthermore, since the ends of each column and row of the Manhattan grid wrap around, the distances may be calculated in either direction. Therefore, the four computational blocks 406 may calculate the following four distances:

$$\begin{matrix}{d}_{1} = \vert {o}_{a} - {o}_{b} \vert + \vert {s}_{a} - {s}_{b} \vert \\ {d}_{2} = \vert {o}_{a} - {o}_{b} \vert + {N}_{s} - \vert {s}_{a} - {s}_{b} \vert \\ {d}_{3} = {N}_{o} - \vert {o}_{a} - {o}_{b} \vert + \vert {s}_{a} - {a}_{b} \vert \\ {d}_{4} = {N}_{o} - \vert {o}_{a} - {o}_{b} \vert + {N}_{s} - \vert {s}_{a} - {a}_{b} \vert\end{matrix}$$

Where d₁, d₂, d₃, and d₄ are the four possible distances between satellite a and satellite b, and the output 414 of the distance module may be calculated as the minimum of the four distances, d₁, d₂, d₃, and d₄.

$$Output = min ( {d}_{1} , {d}_{2} , {d}_{3} , {d}_{4} )$$

Using the previous example from FIG. 1 where the source satellite is at address (0, 1) 110 and the destination satellite is at address (2, 0) 108, we have Nₒ=4 and Nₛ=4, oₐ=0, o_{b}=2, sₐ=1, and s_{b}=0, and;

$$\begin{matrix}{d}_{1} = \vert {o}_{a} - {o}_{b} \vert + \vert {s}_{a} - {s}_{b} \vert = \vert 0 - 2 \vert + \vert 1 - 0 \vert = 3 \\ {d}_{2} = \vert {o}_{a} - {o}_{b} \vert + {N}_{s} - \vert {s}_{a} - {s}_{b} \vert = \vert 0 - 2 \vert + 4 - \vert 1 - 0 \vert = 5 \\ {d}_{3} = {N}_{o} - \vert {o}_{a} - {o}_{b} \vert + \vert {s}_{a} - {a}_{b} \vert = 4 - \vert 0 - 2 \vert + \vert 1 - 0 \vert = 3 \\ {d}_{4} = {N}_{o} - \vert {o}_{a} - {o}_{b} \vert + {N}_{s} - \vert {s}_{a} - {a}_{b} \vert = 4 - \vert 0 - 2 \vert + 4 - \vert 1 - 0 \vert = 5 \\ and ; \\ Output = min ( 3 , 5 , 3 , 5 ) = 3\end{matrix}$$

Note that two of the distances lead to the same minimum distance of 3. As discussed with regards to FIG. 2, though multiple routes may give the same distance, geographic aspects of the routes might result in one route being shorter than the other. For example, in the example of FIG. 2, a forwarding system for a packet travelling from network node 202 to network node 204 should give preference to going in the North direction first, and then in the East direction.

In embodiment, an ECMP hint 306 in packet 300 may be input to the forwarding system if one direction is preferred over another direction. This may be encoded in various ways based on the network geometry. For a Manhattan grid geometry, a minimal way to encode this information could use 3 values; a north/south preference, an east/west preference, or no preference. In embodiments where the columns and rows of the Manhattan grid network are not aligned with the cardinal direction, different terminology may be used for the column or row preferences. A more complex coding scheme could rank each direction by preference. This field would take at least 2 bits in the packet header.

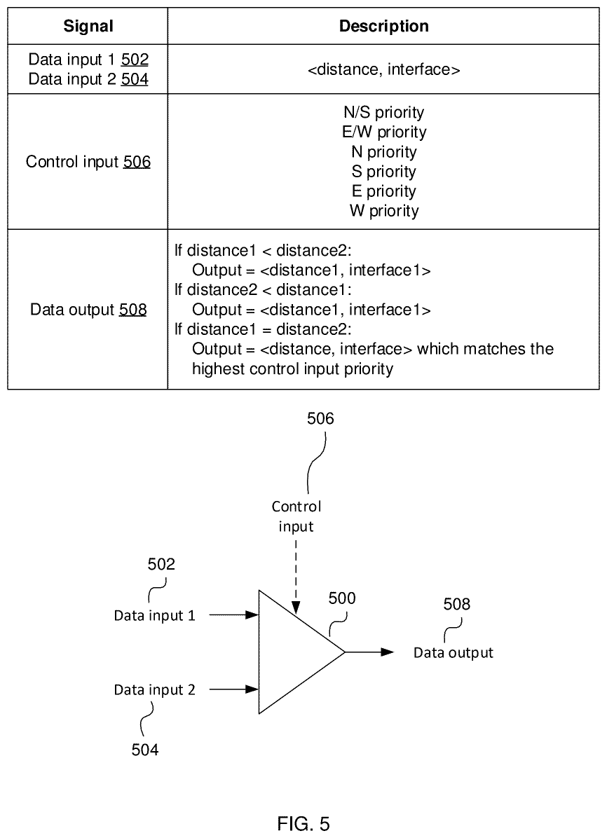

FIG. 5 illustrates a controlled comparator 500, according to an embodiment, that may be used as building blocks within an ECMP module 500. The comparator 500 may function as a normal comparator, outputting the minimum of the two inputs 502 and 504. However, when data input 1 502 and data input 2 504 are equal, the comparator 500 may use the control input to choose the data output 508. In embodiments, the control input 506 may be the ECMP hint 306. The table describes the behavior of a controller comparator 500. The comparator 500 may receive two or more inputs, such as data input 1 502 and data input 2 504. Comparator 500 may also receive control input 506 that may be one or more bits, and which may also be an ECMP hint 306. Control input 506 may indicate a forwarding priority which may be a cardinal direction such as north/south, east/west, or north, south, east, west individually. Other labels may also be used to indicate direction in the other manners. Data output 508 may implement various methods of selecting between the data inputs. For example, data output 508 may output a minimum distance of the data inputs together with the interface of the network node that is associated with the data input selected. In the case where both data inputs represent equal distances, the control input 506 may be used to select the output distance and interface which matches the highest control input priority.

It should be understood that network node addresses, distances, and interfaces are related. A network node may be represented by an address, such as a row, column combination in the case of a Manhattan grid network. In embodiments including a satellite constellation with a Manhattan grid network geometry, a network node's address may be represented by an orbit, satellite combination. In these cases, the network node's address also indicates its geographic position within the network and may be used to determine the distance between two network nodes. As the distance is related to a particular route between the two network nodes, it is also related to the forwarding direction of a sending network node.

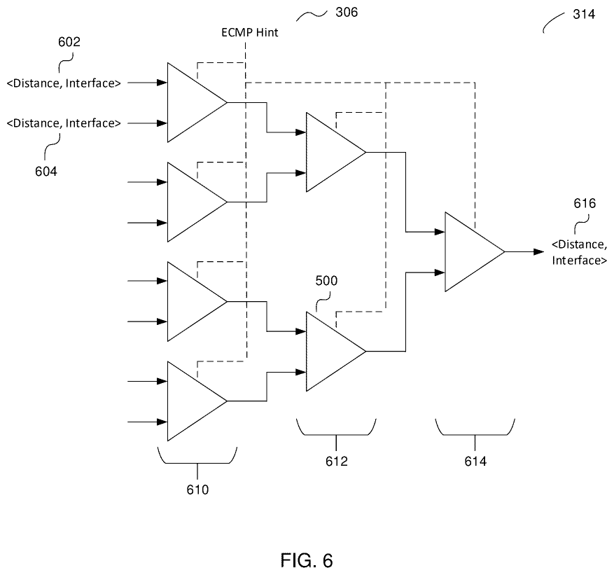

FIG. 6 illustrates an ECMP module 314, according to an embodiment. The ECMP module 314 includes controlled comparators 500 arranged in stages 610, 612, and 614 to select the best interface to forward a received packet. The distances in each of the inputs are compared using a network of controlled comparators 500 to select the interface with the minimum distance to the destination network node. The ECMP module 314 outputs the shortest distance and the corresponding interface to be used to forward the packet.

ECMP module 314 includes a network of controlled comparators 500 organized into three stages. The ECMP module 314 receives eight <distance, interface> tuples, such as tuple 602 and tuple 604, from eight distance modules 312 as illustrated in FIG. 3. The comparators 500 arranged in a binary tree so that the first stage 610 receives the eight input tuples and outputs four resulting <distance, interface> tuples, the second stage 612 receives the four resulting tuples and outputs two. Finally, the last stage includes a single comparator and outputs the final resulting <distance, interface> tuple 616. The ECMP hint 306 is distributed to all the comparators 500 and may be used as described herein.

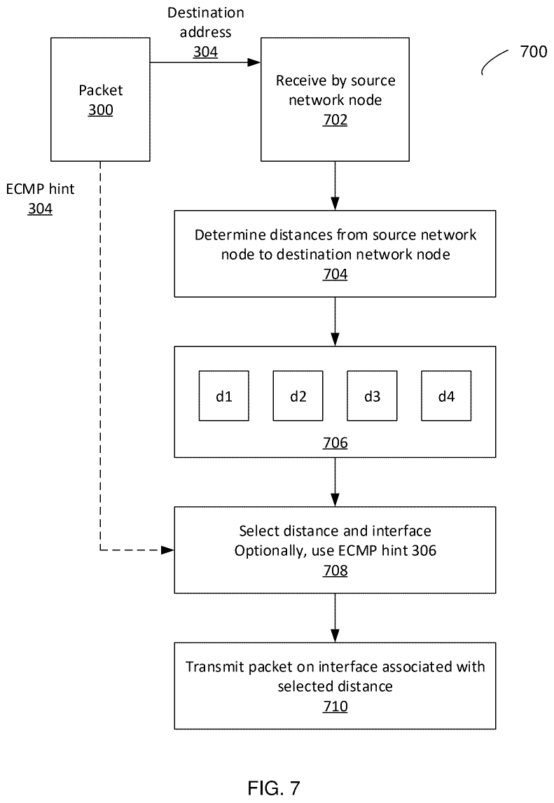

FIG. 7 illustrates a method 700 for routing a packet in a network with a Manhattan geometry according to an embodiment. In step 702, the method starts by a source network node receiving a packet 300 and extracting a destination address 304 from the packet. The destination address specifies a destination network node. In embodiments, the network has a Manhattan grid geometry including a plurality of columns and a plurality of rows with a network node located at intersections of the plurality of columns and the plurality of rows. Links aligned with the plurality of columns and the plurality of rows communicatively connect the plurality of network nodes. For routing purposes and for calculating distances, each of the plurality of links has a nominal routing cost of one hop. The plurality of links including additional links connecting respective opposing ends of each of the plurality of columns and opposing ends of each of the plurality of rows to that each of the rows and columns “wrap around,” and allowing packets to be transmitted in either direction along the rows and columns.

In step 704, the source network node determines a plurality of distances between the source network node and the destination network node. Each of the plurality of distances may be determined by adding a vertical distance in rows between the source network node and the destination network node and a horizontal distance in columns between the source network node and the destination network node. Due to the Manhattan grid geometry with opposing ends of rows and opposing ends of columns connected, the vertical distance may be measured in both directions along a source row where the source network node is located, and the horizontal distance may be measured in both directions along a source column where the source network node is located. In step 706, four distances may be determined based on travelling in each of the horizonal (row) direction and in the vertical (column) direction in both opposing directions as illustrated in FIG. 1. In step 708, the source network node may select a minimum distance from the plurality of distances. When selecting the minimum distance, an optional routing (i.e., an ECMP) hint 306 may be used to decide when two or more distances are the same or to give preference to routing in one direction over another. In other words, the ECMP hint 306 may be used to favor routing in a column direction over a row direction or vice versa. Note that each distance may be associated with an interface of the source node in that the source node forwarding the packet on a particular output interface transmits the packet along a route of length given by the distance. Finally, in step 710, the source network node may transmit or forward the packet on a selected interface associated with the minimum distance.

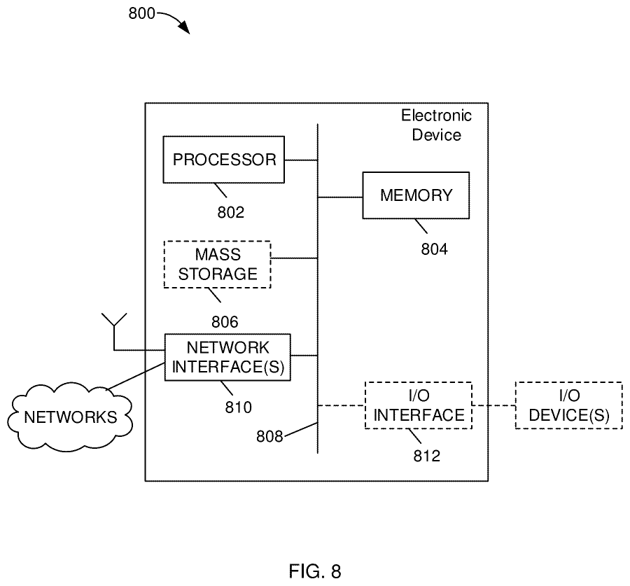

FIG. 8 illustrates an electronic device 800, according to an embodiment, that may perform any or all of operations of the methods and features explicitly or implicitly described herein, according to one or more aspects of the disclosure. For example, a network node equipped with network interfaces may be configured as network node 108 or 110.

As shown, the apparatus 800 may include a processor 802, such as a Central Processing Unit (CPU) or specialized processors such as a Graphics Processing Unit (GPU) or other such processor unit, memory 804, non-transitory mass storage 806, input-output (I/O) interface 812, and network interface(s) 810, all of which are communicatively coupled via bi-directional bus 808. According to certain aspects, any or all of the depicted elements may be utilized, or only a subset of the elements. Further, electronic service 800 may contain multiple instances of certain elements, such as multiple processors, memories, or transceivers. Also, elements of the hardware device may be directly coupled to other elements without the bi-directional bus. Additionally, or alternatively to a processor and memory, other electronics, such as integrated circuits, may be employed for performing the required logical operations.

Memory 804 may include any type of non-transitory memory such as static random-access memory (SRAM), dynamic random-access memory (DRAM), synchronous DRAM (SDRAM), read-only memory (ROM), any combination of such, or the like. The mass storage element 806 may include any type of non-transitory storage device, such as a solid-state drive, hard disk drive, a magnetic disk drive, an optical disk drive, USB drive, or any computer program product configured to store data and machine executable program code. According to certain aspects, memory 804 or mass storage 806 may have recorded thereon statements and instructions executable by the processor 802 for performing any of the aforementioned method operations described above.

Embodiments of the present invention can be implemented using electronics hardware, software, or a combination thereof. In some embodiments, the invention is implemented by one or multiple computer processors executing program instructions stored in memory. In some embodiments, the invention is implemented partially or fully in hardware, for example using one or more field programmable gate arrays (FPGAs) or application specific integrated circuits (ASICs) to rapidly perform processing operations.

Actions associated with methods described herein can be implemented as coded instructions in a computer program product. In other words, the computer program product is a computer-readable medium upon which software code or instructions is recorded to execute the method when the computer program product is loaded into memory and executed on a processor of a computing device.

Further, each operation of the method may be executed on any real or virtual computing device, such as a personal computer, server, tablet, smartphone, or the like and pursuant to one or more, or a part of one or more, program elements, modules or objects generated from any programming language, such as C++, Java, or the like. In addition, each operation, or a file or object or the like implementing each said operation, may be executed by special purpose hardware or a circuit module designed for that purpose.

It is obvious that the foregoing embodiments of the invention are examples and can be varied in many ways. Such present or future variations are not to be regarded as a departure from the spirit and scope of the invention, and all such modifications as would be obvious to one skilled in the art are intended to be included within the scope of the following claims.

What is claimed is:

1. A method, comprising:
receiving, by a source network node, a packet;
extracting, by the source network node, a destination address from the packet, the destination address specifying a destination network node in a network, the network having a Manhattan grid geometry including a plurality of columns and a plurality of rows, a plurality of network nodes being located at intersections of the plurality of columns and the plurality of rows with a plurality of links aligned with the plurality of columns and the plurality of rows connecting the plurality of network nodes, each of the plurality of links having a nominal routing cost of one hop, the plurality of links including additional links connecting respective opposing ends of each of the plurality of columns and opposing ends of each of the plurality of rows, and the source network node and the destination network node being included in the plurality of network nodes;
determining, by the source network node, a plurality of distances between the source network node and the destination network node, each distance of the plurality of distances determined by adding a vertical distance in rows between the source network node and the destination network node and a horizontal distance in columns between the source network node and the destination network node, the vertical distance being measured in two directions along a source row where the source network node is located, the horizontal distance being measured in two directions along a source column where the source network node is located;
selecting, by the source network node, a target minimum distance from the plurality of distances; and
transmitting, by the source network node, the packet on an interface associated with the target minimum distance.

2. The method of claim 1, further comprising:
receiving, by the source network node, an equal cost multi-path (ECMP) hint; and
wherein, when at least two distances of the plurality of distances are all equal to a minimum distance, selecting, by the source network node, the target minimum distance from the plurality of distances comprises:
selecting, by the source network node, utilizing the ECMP hint, the target minimum distance from the at least two distances of the plurality of distances.

3. The method of claim 2, wherein the ECMP hint indicates selecting a distance along the plurality of rows over a distance along the plurality of columns.

4. The method of claim 2, wherein the ECMP hint indicates no preference.

5. The method of claim 1, wherein the network is a satellite network, and the plurality of network nodes are satellites, the plurality of columns include a plurality of orbits in a longitudinal direction, the plurality of links aligned with the plurality of columns include a plurality of intra-orbital links, and the plurality of links aligned with the plurality of rows include a plurality of inter-orbital links.

6. A method, comprising:
receiving, by a source network node, a packet and extracting a destination address from the packet, the destination address specifying a destination network node in a network, the network having a Manhattan grid geometry including a plurality of columns and a plurality of rows, a plurality of network nodes being located at intersections of the plurality of columns and the plurality of rows with a plurality of links aligned with the plurality of columns and the plurality of rows connecting the plurality of network nodes, each of the plurality of links having a nominal routing cost of one hop, the plurality of links including additional links connecting respective opposing ends of each of the plurality of columns and opposing ends of each of the plurality of rows, and the source network node and the destination network node being included in the plurality of network nodes;
determining, by the source network node, a plurality of distances between the source network node and the destination network node;
receiving, by the source network node, an equal cost multi-path (ECMP) hint;
when at least two distances of the plurality of distances are equal to a minimum distance, selecting, by the source network node, utilizing the ECMP hint, a target minimum distance from the at least two distances of the plurality of distances; and
transmitting, by the source network node, the packet on an interface associated with the target minimum distance.

7. The method of claim 6, wherein each distance of the plurality of distances is combined with an associated interface of the source network node into a distance-interface tuple, each of the distance-interface tuples including a distance between the source network node and the destination network node, and an interface to transmit the packet to reach the destination network node on a route of a length equal to the respective distance, the respective distance being expressed as a number of hops in the route.

8. The method of claim 6, wherein the network is a satellite network, and the plurality of network nodes are satellites, the plurality of columns includes a plurality of orbits in a longitudinal direction, the plurality of links aligned with the plurality of columns include a plurality of intra-orbital links, and the plurality of links aligned with the plurality of rows include a plurality of inter-orbital links.

9. The method of claim 6, wherein the ECMP hint indicates selecting a distance along the plurality of rows over a distance along the plurality of columns.

10. The method of claim 6, wherein the ECMP hint indicates no preference.

11. A network node, the network node comprising:
at least one processor; and
non-transitory computer readable media storing instructions that are executable by the at least one processor, to cause the network node to:
receive addresses of a plurality of other network nodes and a plurality of output interfaces associated with the plurality of other network nodes;
receive a destination address of a packet in a network;
compute a plurality of distances between a source network node and a destination network node indicated by the destination address, based on the addresses of the plurality of other network nodes and the plurality of output interfaces associated with the plurality of other network nodes; and
a comparator circuit, configured to:
receive the plurality of distances and the plurality of output interfaces, and to receive an equal cost multi-path (ECMP) hint; and
determine a target minimum distance and an output interface corresponding to the target minimum distance.

12. The network node of claim 11, wherein the network node is the source network node.

13. The network node of claim 11, wherein the network is a Manhattan grid network including a plurality of columns and a plurality of rows, the network node, the destination network node, and the plurality of other network nodes being located at intersections of the plurality of columns and the plurality of rows with a plurality of links aligned with the plurality of columns and the plurality of rows connecting the network node, the destination network node, and the plurality of other network nodes, each of the plurality of links having a nominal routing cost of one hop, the plurality of links including additional links connecting respective opposing ends of each of the plurality of columns and opposing ends of each of the plurality of rows.

14. The network node of claim 13, wherein the ECMP hint gives priority to a distance along the plurality of rows over a distance along the plurality of columns.

15. The network node of claim 13, wherein the network is a satellite network, and the network node, the destination network node, and the plurality of other network nodes are satellites, the plurality of columns include a plurality of orbits in a longitudinal direction, the plurality of links aligned with the plurality of columns include a plurality of intra-orbital links, and the plurality of links aligned with the plurality of rows include a plurality of inter-orbital links.

16. The network node of claim 13, wherein the distance is determined by adding a vertical distance in rows between the network node and the destination network node and a horizontal distance in columns between the network node and the destination network node, the vertical distance being measured in two directions along a source row where the source network node is located, the horizontal distance being measured in two directions along a source column where the source network node is located.

17. The network node of claim 11, wherein the target minimum distance is a minimum of the distances in the plurality of distances.

18. The network node of claim 11, wherein at least two minimum distances of the plurality of distances are equal and the ECMP hint is used to select the target minimum distance between the at least two minimum distances.

19. The network node of claim 11, wherein the ECMP hint indicates no preference.
